(19) United States
(12) Patent Application Publication
(10) Pub. No.: US 2023/0105732 A1
(43) Pub. Date: Apr. 6, 2023

(54) CONTROL SYSTEM FOR A PAVING MACHINE

(71) Applicant: Caterpillar Paving Products Inc., Brooklyn Park, MN (US)

(72) Inventor: Dana W. MILLER, Rogers, MN (US)

(73) Assignee: Caterpillar Paving Products Inc., Brooklyn Park, MN (US)

(21) Appl. No.: 17/448,093

(22) Filed: Sep. 20, 2021

(51) Int. Cl. E01C 19/48

(52) U.S. Cl. CPC E01C 19/4873; E01C 2301/16

(57) ABSTRACT

A paving system includes a paving machine, including a hopper, a conveyor, an auger, a screed assembly, and one or more tracks. The paving system also includes one or more obstacle detection elements positioned on the paving machine. The paving system further includes a controller in communication with the one or more obstacle detection elements and one or more of the conveyor, the auger, the screed assembly, and the one or more tracks. The controller is configured to receive information from the one or more obstacle detection elements, and control one or more of a width of the screed assembly, an angle of attack of the screed assembly, a height of the screed assembly, an angle of the screed assembly, or a speed of the paving machine in order to maintain a desired height of paving material delivered to a ground surface by the paving machine.

### TECHNICAL FIELD

The present disclosure relates generally to a road construction machine, and more particularly, to a control system for a paving machine.

### BACKGROUND

The present disclosure relates to paving machines that are used in road surface construction and repairs. Paving machines are typically utilized to lay asphalt or other paving material. Paving machines often include adjustable width screed assemblies. Paving often includes exact measurements and positioning of the paving machine over the paving surface, including the width of the screed assembly. Navigating the paving machine and adjusting the width or other parameters of the screed assembly, for example, to avoid various objects on the road surface, over the course of a paving operation can be mentally and/or physically taxing, potentially leading to user errors. Additionally, significant training and/or experience may be necessary for the operator or operators to navigate the paving machine and/or adjust the width of the screed. Furthermore, a number of operators may be required to steer and otherwise operate the paving machine.

European Patent No. 1118713, issued to Meyer et al. on Oct. 13, 2004 (the '713 patent”), describes machines and methods of operating machines for automatically moving the machine on a planned route using a geodetic or global positioning system. The machine is a road finisher, for example, a slip-form paver. The '713 describes a machine that receives a predetermined work plan that includes the position of obstacles on a work site. The work plan is a part of a pre-planned route, and the machine automatically steers and adjusts (i.e., increases or decreases) a working width in order to avoid the obstacles while performing a paving operation. Specifically, the '713 patent employs the geodetic or global positioning system in order to determine the position of the machine relative to the positions of the known obstacles in the predetermined work plan. However, the '713 patent relies on the geodetic or global positioning system. Furthermore, the'713 patent relies on a predetermined work plan for the position of the obstacles on the work site.

The paving machine, including the systems and methods, of the present disclosure may address or solve one or more of the problems set forth above and/or other problems in the art. The scope of the current disclosure, however, is defined by the attached claims, and not by the ability to solve any specific problem.

### SUMMARY

In one aspect, a paving system may include a paving machine, including a hopper, a conveyor, an auger, a screed assembly, and one or more tracks. The paving system also may include one or more obstacle detection elements positioned on the paving machine. The paving system further may include a controller in communication with the one or more obstacle detection elements and one or more of the conveyor, the auger, the screed assembly, and the one or more tracks. The controller may be configured to receive information from the one or more obstacle detection elements, and may control one or more of a width of the screed assembly, an angle of attack of the screed assembly, a height of the screed assembly, an angle of the screed assembly, or a speed of the paving machine, in order to maintain a desired height of paving material delivered to a ground surface by the paving machine.

In another aspect, a method of automatically or semi-automatically navigating a paving machine in a paving operation may include automatically or semi-automatically navigating the paving machine over a worksite, monitoring one or more obstacle detection elements positioned on the paving machine to detect one or more obstacles in a paving course of the paving machine on the worksite, and if one or more obstacles are detected, maneuvering or adjusting one or more portions of the paving machine. The method may further include determining whether the one or more obstacles have been avoided, maneuvering or adjusting the one or more portions of the paving machine to the original configuration, and continuing automatically or semi-automatically navigating the paving machine over the worksite.

In yet another aspect, a paving machine may include a conveyor, a screed assembly, including a main screed, a left screed extender, and a right screed extender, one or more tracks, one or more obstacle detection elements positioned on the paving machine, and a controller in communication with the one or more obstacle detection elements and one or more of the conveyor, the screed assembly, and the one or more tracks. The controller may be configured to receive information from the one or more obstacle detection elements, and control one or more of an extension or retraction of the left screed extender and the right screed extender relative to the main screed, an angle of attack of the screed assembly, a height of the screed assembly, an angle of the screed assembly, or a speed of the one or more tracks to avoid or accommodate one or more obstacles in a path of the paving machine.

### BRIEF DESCRIPTION OF THE DRAWINGS

FIG. 1 is an illustration of an exemplary paving machine, according to aspects of this disclosure.

FIG. 2 is an illustration of a front view of the exemplary paving machine, including a hopper and conveyor assembly, according to aspects of this disclosure.

FIG. 3 is a schematic representation of an angle of attack of an exemplary screed assembly, according to aspects of this disclosure.

FIGS. 4A and 4B are schematic representations of the exemplary screed assembly of the exemplary paving machine, according to aspects of this disclosure.

FIG. 5 is a schematic view of a control system of the exemplary machine of FIG. 1, according to aspects of this disclosure.

FIG. 6 is a flowchart depicting an exemplary method for identifying one or more obstacles and maneuvering or adjusting one or more portions of the paving machine, according to aspects of this disclosure

### DETAILED DESCRIPTION

Both the foregoing general description and the following detailed description are exemplary and explanatory only and are not restrictive of the features, as claimed. As used herein, the terms “comprises,” “comprising,” “having,” “including,” or other variations thereof, are intended to cover a non-exclusive inclusion such that a process, method, article, system, or apparatus that comprises a list of elements does not include only those elements, but may include other elements not expressly listed or inherent to such a process, method, article, or apparatus. Further, relative terms, such as, for example, “about,” “substantially,” “generally,” and “approximately” are used to indicate a possible variation of ±10% in a stated value.

For the purpose of this disclosure, the term “ground surface” is broadly used to refer to all types of surfaces that form typical roadways (e.g., asphalt, cement, clay, sand, dirt, etc.) or upon which paving material may be deposited in the formation of roadways. Although the current disclosure is described with reference to a paving machine, this is only exemplary. In general, the current disclosure can be applied as to any machine, such as, for example, a paver finisher, asphalt finisher, or another machine that moves over the ground surface of a worksite.

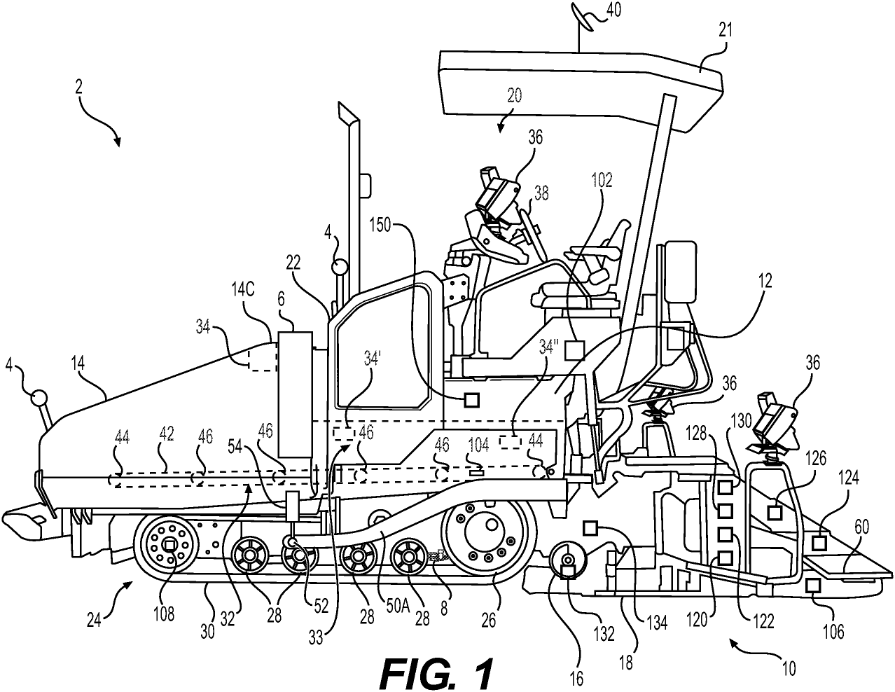

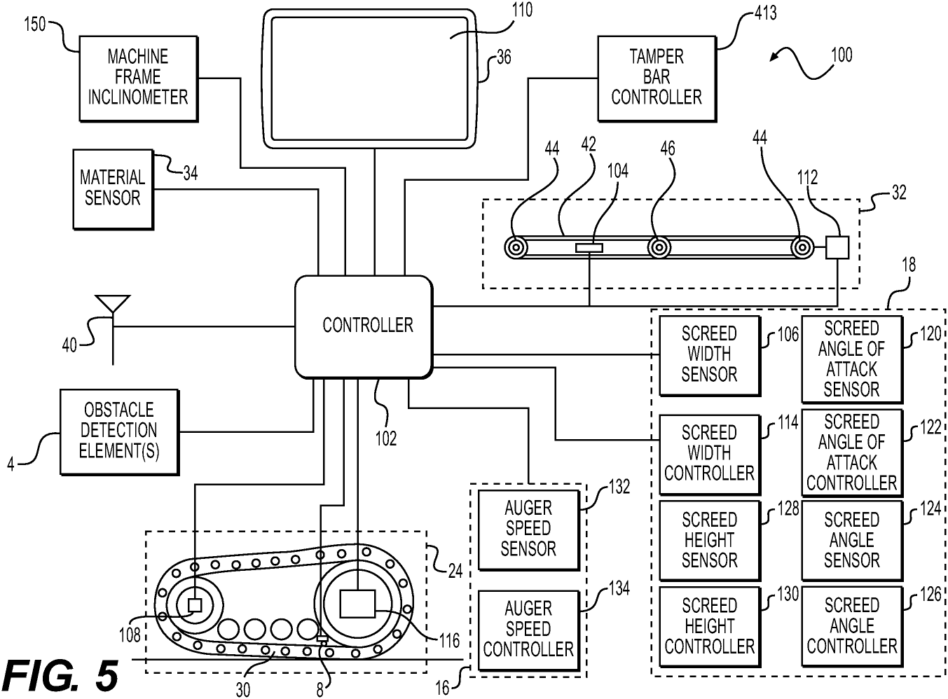

FIG. 1 illustrates a side view of an exemplary paving machine 2, according to the present disclosure. Machine 2 may be any size paver with any paving width. In one aspect, machine 2 may be a small paver, for example, with a maximum paving width of approximately 5.5 meters. Alternatively, in another aspect, machine 2 may be a large paver, for example, with a maximum paving width of approximately 11 meters. In one or more aspects, machine 2 includes one or more obstacle detection elements 4, for example, positioned on or otherwise coupled to a forward portion of machine 2. In these aspect, machine 2 also includes a control system 100 (FIG. 5), which may control one or more components of machine 2 in response to images, data, information, etc. detected by obstacle detection element(s) 4. For example, machine 2 may include a screed assembly 10, and control system 100 may adjust one or more components or aspects of screed assembly 10 in response to the images, date, information, etc. detected by obstacle detection element(s) 4.

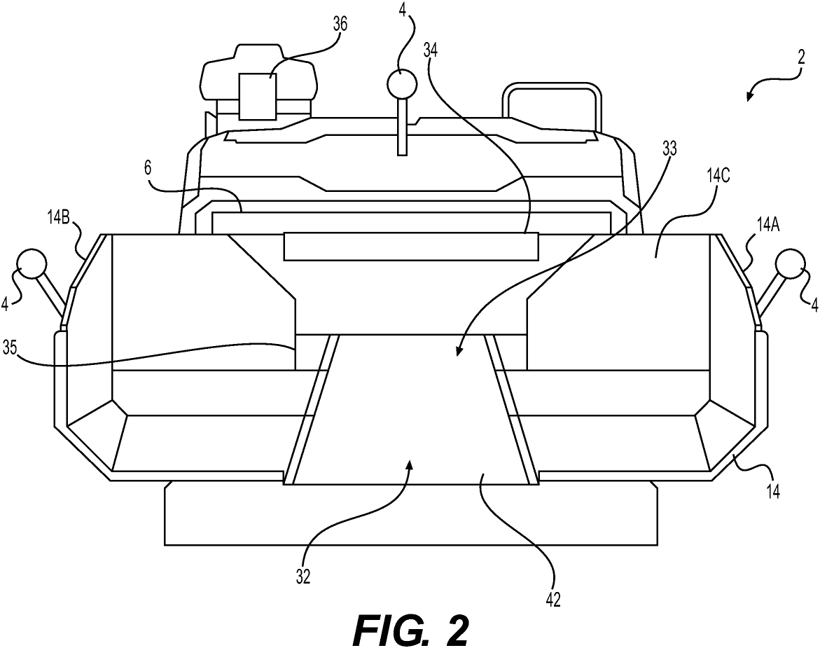

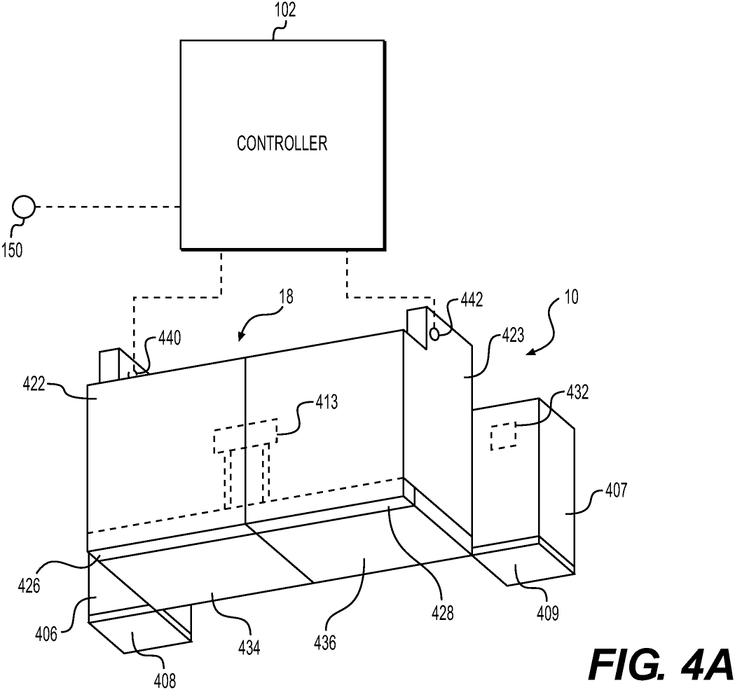

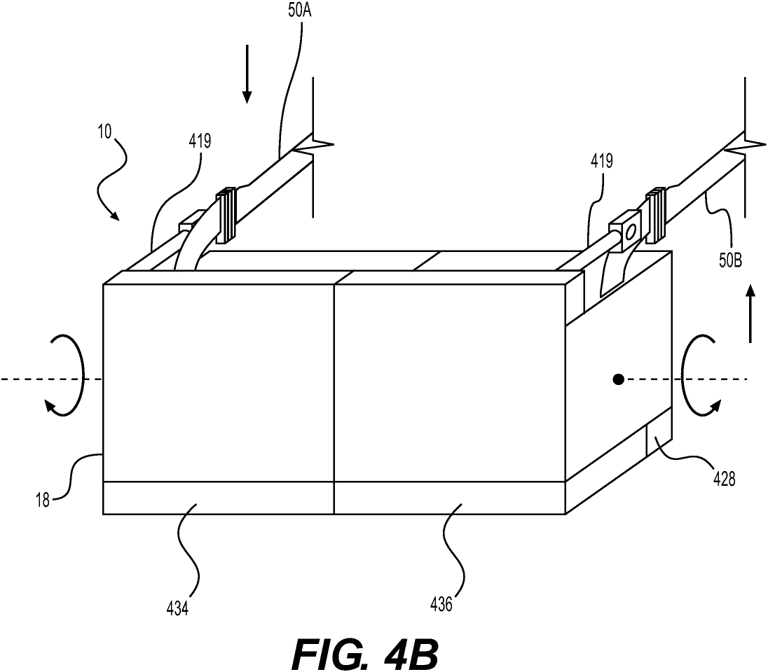

Machine 2 includes screed assembly 10, a frame 12, and a hopper 14. As discussed in detail below, screed assembly 10 may include an auger 16, a main screed 18, and one or more screed extensions 406, 407 (FIG. 4A). Machine 2 may also include an operator station 20, from which one or more operators may maneuver and control machine 2. Operator station 20 may be at least partially covered by a canopy 21. Machine 2 may be propelled by an engine assembly 22 to power a drive assembly 24, which may include a drive wheel 26, one or more idlers 28, and tracks 30. Machine 2 includes a conveyor assembly 32 to transport paving material through a tunnel 33 (FIG. 2) from hopper 14 to auger 16 and screed assembly 10. Machine 2 may also include one or more material sensors 34 to detect and/or measure an amount of paving material being carried by conveyor assembly 32. Additionally, machine 2 may include one or more control panels 36, for example, positioned in operator station 20 next to a steering wheel 38, in one or more operator positions 60 on screed assembly 10, remote from machine 2, etc. Control panels 36 may control and/or display information regarding one or more aspects of machine 2 via a controller 102. Machine 2 may include a tank 6 and one or more spray bars 8 to store and/or deliver a treatment fluid to the ground surface. In one or more aspects and as discussed in detail below, control system 100 may control one or more aspects of machine 2, for example, auger 16, screed assembly 10, drive assembly 24, conveyor assembly 32, spray bar 8, etc., in response to images, data, information, etc. detected by obstacle detection element(s) 4.

Obstacle detection element(s) 4 may include one or more cameras, optical sensors, radar sensors, sonar sensors, etc. to scan for or otherwise detect one or more obstacles ahead and/or around the surroundings of machine 2, for example, in the path of machine 2 during a paving operation. One or more obstacle detection elements 4 may be positioned on the front of machine 2, for example, forward of operator station 20 and/or extending from engine assembly 22. In some aspects and as shown in FIG. 2, machine 2 may include two obstacle detection elements 4, for example, positioned on left and right portions of machine 2, for example, on side portions 14A and 14B of hopper 14. Obstacle detection element(s) 4 may scan, detect, and/or emit one or more signals (e.g., light, radio waves, sound waves, etc.), and based on the received reflected or otherwise detected signals from an obstacle, obstacle detection element(s) 4 may determine a distance between obstacle detection element(s) 4 and the obstacle, and thus a distance between machine 2 and the obstacle. Furthermore, obstacle detection element(s) 4 may determine a position of the obstacle relative to machine 2. For example, obstacle detection element(s) 4 allow machine 2 to measure a distance and relative position between machine 2 and one or more obstacles. In these aspects, obstacle detection element(s) 4 may detect one or more of a curb, a road shoulder, a berm, an island, a guardrail, a mailbox, a retaining wall, a manhole cover, a pile of asphalt or other material(s), or other topographical features, impediments, materials, or objects on the worksite. The one or more obstacle detection element(s) 4 are in communication with controller 102. In one aspect, a plurality of obstacle detection element(s) 4 may be used to create a three-dimensional point cloud of at least a portion the surroundings of machine 2, for example, the surroundings ahead of machine 2 in a direction of travel.

One or more obstacle detection element(s) 4 may help machine 2 maneuver and/or control one or more portions of machine 2 in order to avoid or otherwise react to one or more obstacles on the worksite. For example, obstacle detection element(s) 4 may be in communication with controller 102, and controller 102 may be configured to categorize the detected obstacles and control one or more aspects of machine 2 to avoid or otherwise react to the detected obstacle(s). As discussed in detail below, maneuvering and/or controlling one or more portions of machine 2 may include maneuvering and/or adjusting one or more of auger 16, screed assembly 10, drive assembly 24, conveyor assembly 32, spray bar 8, etc. in response to images, data, information, etc. detected by obstacle detection element(s) 4.

As shown in FIGS. 1 and 2, hopper 14 may be positioned in a forward portion of frame 12 of machine 2 to receive or store the paving material (e.g., asphalt), for example, from a mixer truck ahead of machine 2. As shown in FIG. 2, hopper 14 may include side portions 14A and 14B, which may be controllable to be lifted upward to help direct paving material within hopper 14 toward conveyor assembly 32. Hopper 14 also includes a rear portion 14C, which may help separate hopper 14 from tank 6, engine assembly 22, and other components of machine 2. Moreover, as also shown in FIG. 2, hopper 14 may include a window 35 formed by an opening in rear portion 14C in order for conveyor assembly 32 to extend and carry paving material into tunnel 33. Window 35 may also limit and/or restrict a height and/or a width of paving material being conveyed by conveyor assembly 32 in tunnel 33. For example, window 35 includes a height and a width. The width of window 35 may correspond to the width of conveyor assembly 32, or may be wider than the width of conveyor assembly 32, as shown in FIG. 2. The height of window 35 may limit a height of paving material conveyed on conveyor assembly 32 from hopper 14.

As mentioned, conveyor assembly 32 connects hopper 14 to auger 16 in a rear portion of machine 2 to convey the paving material. Conveyor assembly 32 may extend beneath engine assembly 22 and operator station 20, and may be positioned above drive assembly 24. Conveyor assembly 32 may include at least one conveyor belt 42 driven by at least one conveyor pulley 44. In one example, conveyor assembly 32 may include two conveyor pulleys 44, for example, one in a forward position and one in a rear position. For example, conveyor pulleys 44 may each rotate in order to drive conveyor belt 42 to deliver paving material from hopper 14 to auger 16. In another example, conveyor assembly 32 may include two conveyor belts 42, with each conveyor belt 42 being driven independently by a respective conveyor pulley 44. In one aspect, conveyor belt(s) 42 may travel over one or more plates or supports 46, which may help support conveyor belt(s) 42. Moreover, as shown in FIG. 2, conveyor assembly 32 may extend from a central position of hopper 14.

Although not shown, as mentioned above, conveyor assembly 32 may include two or more conveyor belts 42. The two or more conveyor belts 42 may extend parallel to one another from hopper 14 to respective sides of auger 16 or two respective augers 16. Conveyor belt(s) 42 may be separately controlled and/or driven, or may controlled together or otherwise linked. The speed of conveyor belt(s) 42 may be controlled by controller 102 and may be determined based on, for example, a desired delivery rate of paving material to auger 16 and screed assembly 10 and/or a speed of machine 2. In these aspects, as discussed below, control system 100 may include a conveyor speed sensor 104 to detect a speed of conveyor belt 42 and a conveyor speed controller 112 to control a speed of conveyor belt 42, for example, via one or more of conveyor pulleys 44.

As shown in FIG. 1, material sensor 34 may be positioned above the junction of conveyor assembly 32 with hopper 14. As shown in FIG. 2, material sensor 34 may be positioned in a central position of hopper 14. For example, material sensor 34 may be positioned at rear portion 14C of hopper 14 above window 35 and/or just forward of where paving material is conveyed from hopper 14 into tunnel 33. Material sensor 34 may be a laser sensor configured to measure a height and/or a cross-sectional area of paving material being carried by conveyor assembly 32. For example, material sensor 34 may emit laser energy downward toward conveyor assembly 32. A portion of the emitted laser energy may be reflected by the paving material on conveyor assembly 32 and may be received by material sensor 34. Material sensor 34 and/or controller 102 may analyze the received energy to determine a distance between sensor 34 and the paving material in order to determine a height of the paving material relative to the conveyor assembly 32 at a position below material sensor 34. Material sensor 34 and/or controller 102 may also analyze the received energy to determine a width of the paving material on the conveyor assembly 32 at the position below material sensor 34. The height of the paving material may change over a width of conveyor assembly 32. Nevertheless, material sensor 34 may measure and/or be programmed with the width of conveyor belt(s) 42, and may then determine a cross-sectional area of the paving material across the width of conveyor assembly 32 below material sensor 34. Material sensor 34 may transmit information regarding the height and/or the cross-sectional area of paving material to controller 102. With the instantaneous height and/or cross-sectional area of paving material and the speed of conveyor belt 42, controller 102 may determine a flow rate of paving material on conveyor belt 42, and thus a delivery rate of paving material by conveyor assembly 32.

In another aspect, material sensor 34 may be a sonic sensor, an optical sensor, or another appropriate sensor to determine the height and/or the cross-sectional area of paving material on conveyor assembly 32. As discussed above, in these aspects, sensor 34 may emit energy toward conveyor assembly 32 and receive reflected energy to determine a distance between material sensor 34 and the paving material, and thus determine a height of the paving material being transported by conveyor assembly 32. Moreover, material sensor 34 may be configured to also emit energy toward hopper 14 and receive reflected energy indicative of one or more heights of paving material within hopper 14, and thus an amount of paving material within hopper 14. For example, such measurements may be used to help ensure a consistent flow of paving material from hopper 14, and/or to provide information regarding the amount of paving material within hopper 14 (e.g., that a mixer truck is required to add paving material to hopper 14). In another aspect, material sensor 34 may be a mechanical level sensor positioned above a portion of conveyor assembly 32. In any of the aforementioned aspects, if machine 2 includes two or more conveyor belts 42, machine 2 may include two or more material sensor 34, with each material sensor 34 being positioned above the respective conveyor belt 42.

As shown in FIG. 1, one or more material sensors may be positioned in other positions relative to conveyor assembly 32. For example, a material sensor 34' may be positioned within tunnel 33 toward the middle of conveyor assembly 32, for example, below engine assembly 22. Alternatively or additionally, a material sensor 34ʺ may be positioned toward the rear of conveyor assembly 32, for example, below operator station 20. Furthermore, material sensor 34ʺ may be positioned at a rearmost position of conveyor assembly 32 where conveyor belt 42 delivers the paving material to auger 16. In any of these aspects, one or more of material sensors 34, 34', and 34ʺ may help determine a delivery rate of paving material by conveyor assembly 32. Moreover, machine 2 may include any arrangement of one or more material sensors 34, 34', and 34ʺ, and controller 102 may receive information from each of the one or more material sensor 34, 34', and 34ʺ to determine a height, and thus a cross-section, of the paving material on conveyor assembly 32. For example, controller 102 may receive information from material sensor 34 and from material sensor 34ʺ to determine whether the cross-sectional area of the paving material changes over a portion of conveyor assembly 32.

Auger 16 may be positioned perpendicular to the direction of travel of machine 2. Auger 16 may include a spiral shape, and may rotate (e.g., clockwise or counterclockwise) to direct paving material delivered by conveyor assembly 32. For example, auger 16 may rotate to direct the paving material toward the sides of machine 2, such that the paving material may be smoothed by screed assembly 10. Additionally, auger 16 may include a plurality of parallel or longitudinally arranged auger sections. In one aspect, although not shown, auger 16 may include a left side auger and a right side auger, which may include different spiral arrangements and/or may rotate in different directions. The left side auger may rotate to direct the paving material toward the left side of machine 2, and the right side auger may rotate to direct the paving material toward the right side of machine 2. Auger 16 may rotate at adjustable rotational speeds, and the rotational speed of auger or the auger sections may be correlated to the speed of conveyor assembly 32. Additionally, the rotation rate of auger 16 (e.g., the rotation rate of the left side auger and/or the rotation rate of the right side auger) may correspond to the speed of the conveyor belt(s) 42 and/or to the speed of machine 2. In these aspects, an auger speed sensor 132 may detect the rotational speed of auger 16, and an auger speed controller 134 may control the rotational speed of auger 16. In one or more aspects, auger speed controller 134 may be coupled to and/or controlled by controller 102.

FIGS. 1, 3, 4A, and 4B illustrate various views of screed assembly 10 or portions of screed assembly 10. Screed assembly 10 is positioned to the rear of frame 12 of machine 2. Screed assembly 10 may be pivotally coupled to a machine 2 and trail behind machine 2 to spread and/or smooth paving material deposited by conveyor assembly 32, for example, to form a mat of paving material. Screed assembly 10 may be connected to machine 2 via two tow arms 50A, 50B (only tow arm 50A is visible in FIG. 1, and tow arm 50B is shown in FIG. 4B) coupled to respective tow points 52 (only one of which is visible in FIG. 1). Tow arms 50A, 50B may be coupled to screed assembly 10 via respective rods 419. Tow arms 50A, 50B may be configured to float so as to be raised and lowered as a function of the amount of paving material at an upstream end of screed assembly 10. The relative position and orientation of screed assembly 10 relative to frame 12 of machine 2 and a mat of paving material may be adjusted by adjusting the tow points 52, in order, for example, to control the thickness of the paving material deposited via machine 2 and/or to adjust the angle of attack of screed assembly 10. Tow arms 50 may be attached to a pair of tow point cylinders 54 (only one of which, tow arm 50A, is visible in FIG. 1). Tow point cylinders 54 may be configured to control the height of tow points 52 by adjusting hydraulic pressures within tow point cylinders 54, thereby controlling the height of tow arms 50.

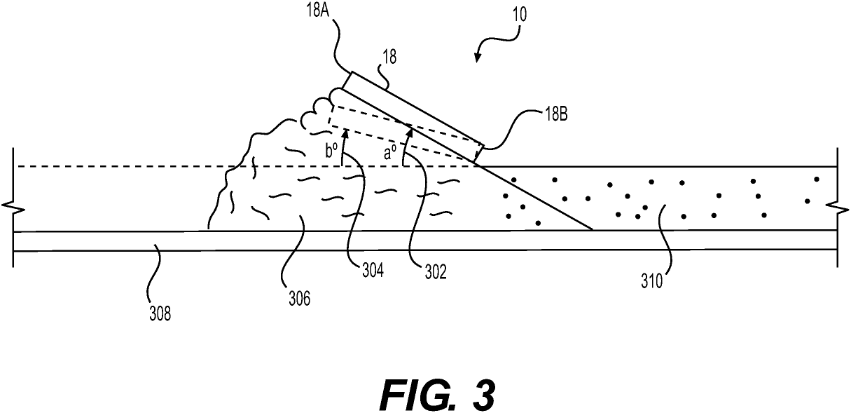

As discussed below and shown in FIGS. 3, 4A, and 4B, the angle of attack of screed assembly 10, the angle of screed assembly 10, the width of screed assembly 10, the height of screed assembly 10, etc. may be adjustable, for example, via control panel 36, controller 102, and/or one or more other controllers. For example, as shown in FIG. 3, screed assembly 10 (with only main screed 18 shown in FIG. 3 for clarity) includes a front end 18A and a rear end 18B, and controller 102 and/or angle of attack controller 122 may control a pitch or angle between front end 18A and rear end 18B to control an angle of attack of screed assembly 10. Control system 100 may include an angle of attack sensor 120 and an angle of attack controller 122, which may be coupled to controller 102 in order for controller 102 to monitor and/or control the angle of attack of screed assembly 10. Control system 100 may include a screed angle sensor 124 and a screed angle controller 126, which may be coupled to controller 102 in order for controller 102 to monitor and/or control the angle of screed assembly 10.

Moreover, as shown in FIGS. 4A and 4B, screed assembly 10 may include one or more extendable sections, for example, a left extender screed 406 and a right extender screed 407. Extender screeds 406 and 407 may help to control the paving width of machine 2. In these aspects, control system 100 may include a screed width sensor 106 and a screed width controller 114, which may be coupled to controller 102 in order for controller 102 to monitor and/or control the width of screed assembly 10. Furthermore, control system 100 may include a screed height sensor 128 and a screed height controller 130, which may be coupled to controller 102 in order for controller 102 to monitor and/or control the height of screed assembly 10, for example, relative to frame 12 of machine 2 and/or relative to the ground surface.

FIG. 3 is a schematic representation of the angle of attack of screed assembly 10. For example, FIG. 3 shows an actual angle of attack 302 of screed assembly 10 (at first angle a°) and a desired angle of attack 304 of screed assembly 10 (at second angle b°) that may be determined by, for example, controller 102. It is noted that, for clarity, only main screed 18 of screed assembly 10 is illustrated in FIG. 3 to show the angle of attack of screed assembly 10. Nevertheless, the angle of attack of left extender screed 406 and right extender screed 407 may be similarly adjustable. As shown in FIG. 3, a supply of paving material 306 may be delivered to a ground surface 308 at a position ahead of screed assembly 10, for example, via conveyor assembly 32 (FIG. 1). The supply of paving material 306 may be spread by auger(s) 16 (not shown). Additionally, screed assembly 10 may spread and/or smooth the supply of paving material 306 to pave or otherwise form a mat 310 on ground surface 308.

The desired angle of attack 304 of screed assembly 10 may be based at least on an operation command received by an operator of machine 2 for controlling screed assembly 10. Alternatively, desired angle of attack 304 of screed assembly 10 may be determined by controller 102 (FIGS. 1 and 5) based on images, data, information, etc. received from obstacle detection element(s) 4 and/or predetermined parameters for the paving operation. Further, the angle of attack of screed assembly 10 may be affected by various factors, including but not limited to, material feed control (e.g., the head of paving material), changes in paving speed, changes in paving width, paving material mix type, take off settings (e.g., null/tow point height), a tamper bar speed, etc. In one example, the angle of attack of screed assembly 10 may be adjusted while machine 2 is performing a paving operation. For example, the angle of attack of screed assembly 10 may be adjusted by changing a height of tow points 52 (e.g., by raising or lowering tow point cylinders 54), changing a tamper bar speed, changing a prestrike off height, adding counter balance, and/or verifying a proper head of paving material ahead of screed assembly 10. The head of material may be adjusted or verified by at least controlling the paving speed of paving machine 2, adjusting the material feed ratio setting of conveyor assembly 32, and/or using feeder sensors to control the level of material at the outboard end of auger(s) 16.

FIGS. 4A and 4B illustrate schematic views of screed assembly 10 and controller 102. Controller 102 may be arranged on any suitable location on machine 2, and screed assembly 10 may be any of a number of configurations such as a fixed width screed, a side extender screed, or a multiple section screed that includes extensions. In one aspect, screed assembly 10 may include main screed 18 with a left screed frame 422 and a right screed frame 423. Left screed frame 422 may include a left inclinometer 440 that may be mounted on an upper portion of left screed frame 422, and right screed frame 423 may include a right inclinometer 442 located on an upper portion of right screed frame 422, as shown in FIG. 4A. Alternatively, inclinometers 440, 442 may be mounted on any other suitable locations of left and right screed frames 422, 423. Inclinometers 440, 442 may each be a part of and/or otherwise connected to screed angle sensor 124. Main screed 18 may also include a left tamper bar 426 and a right tamper bar 428, each of which is connected to a tamper bar controller 413. Tamper bar controller 413 may be configured to control the movement of the tamper bars 426, 428 to adjust the angle of attack of screed assembly 10. For example, tamper bar controller 413 may be a part or of otherwise connected to screed angle of attack controller 122. Additionally, main screed 18 may include a left main screed plate 434 and a right main screed plate 436. Screed assembly 10 may also include left and right extender screeds 406, 407 including left and right extender screed plates 408, 409, respectively.

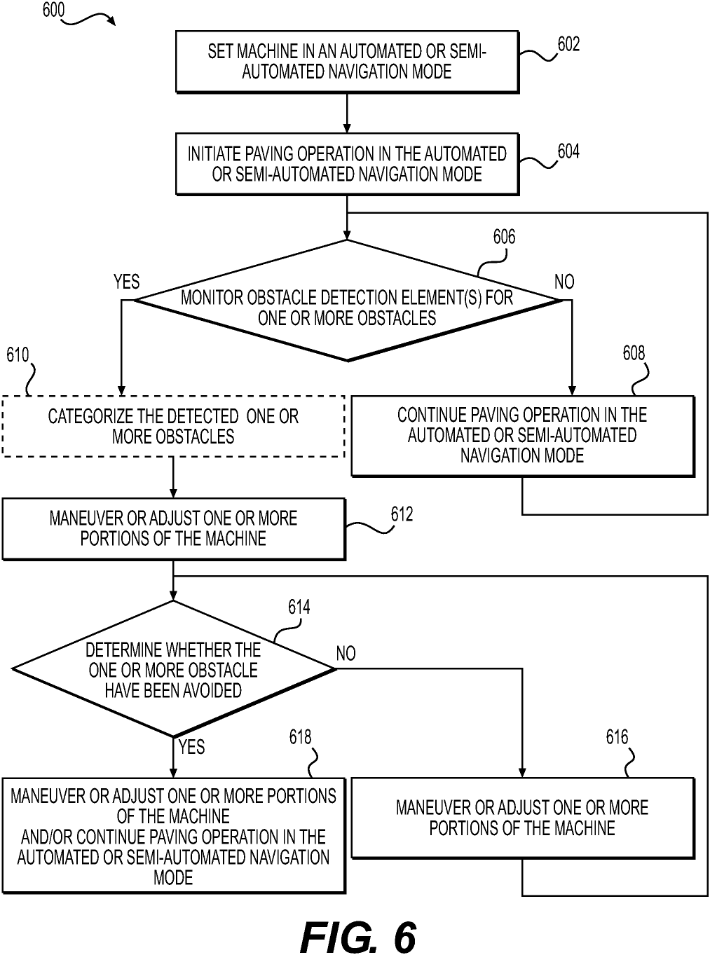

As shown in FIG. 4A, screed width controller 114 may be coupled to one or more portions of screed assembly 10. Additionally, controller 102 may be connected to left and right inclinometers 440, 442 and machine frame inclinometer 150. Controller 102 may receive signals generated by inclinometers 150, 440, 442. Controller 102 may embody a single microprocessor or multiple microprocessors that may include means for determining the angle of attack and/or the cross slope of screed assembly 10. For example, controller 102 may include a memory, a secondary storage device, and a processor, such as a central processing unit or any other means for accomplishing a task consistent with the present disclosure. The memory or secondary storage device associated with controller 102 may be non-transitory computer-readable media that store data and/or software routines that may assist controller 102 in performing its functions, such as the functions of method or process 600 of FIG. 6. Further, the memory or secondary storage device associated with controller 102 may also store data received from various inputs, for example, the signals received from left and right inclinometers 440, 442 and a machine frame inclinometer 150. Numerous commercially available microprocessors can be configured to perform the functions of controller 102. It should be appreciated that controller 102 could readily embody a general machine controller capable of controlling numerous other machine functions. Various other known circuits may be associated with controller 102, including signal-conditioning circuitry, communication circuitry, hydraulic or other actuation circuitry, and other appropriate circuitry.

Additionally, controller 102 may be configured to receive various inputs. The various inputs may be signals received from, for example, at least left and right inclinometers 440, 442 and/or machine frame inclinometer 150. The various inputs may also include information or data from obstacle detection element(s) 4. Alternatively or additionally, the various inputs may include operation control signals of paving machine 2, for example, a speed of paving machine 2, a direction of paving machine 2, a width of screed assembly 10, a height and/or angle of screed assembly 10, a speed of conveyor assembly 32, a speed of rotation of auger 16, a emulsion spray delivery rate, a tow arm position control signal, etc. Controller 102 may determine, based on the various inputs, a desired speed of paving machine 2, a desired direction of paving machine 2, a desired screed width, a desired screed height or angle, a desired conveyor speed, a desired auger speed of rotation, a desired emulsion spray delivery rate, a desired tow arm position control signal, etc. Additionally, controller 102 may determine adjustment values or ratios for the various desired parameters. For example, in one example, controller 102 may determine an actual angle of attack based on the data received from inclinometers 440, 442. Controller 102 may then determine an angle of attack adjustment value based on a measured actual angle of attack and the desired angle of attack of screed assembly 10. Additionally or alternatively, controller 102 may utilize, in addition to inclinometers 440, 442, the signals received from machine frame inclinometer 150. In another aspect, controller 102 may determine a cross slope based at least on the received input signals from inclinometers 440, 442.

Referring to FIGS. 1 and 5, one or more control panels 36 may include or be coupled to (e.g., wired or wirelessly) controller 102. As shown in FIG. 5, controller 102 may also be coupled to (e.g., through a wired or wireless connection) one or more sensors and/or to one or more actuators on machine 2 to form a control system 100. Controller 102 may be coupled to obstacle detection element(s) 4, spray bar 8, and/or position sensor(s) 40 (e.g., a global positioning system antenna, a LIDAR sensor, a stringline sensor, a total station unit to be detected or otherwise sensed by a universal total station monitor positioned on the worksite, etc.). Additionally, as mentioned above and as discussed in detail below, controller 102 may be coupled to one or more of conveyor speed sensor 104, screed width sensor 106, track speed sensor 108, screed angle of attack sensor 120, screed angle sensor 124, screed height sensor 128 and auger speed sensor 132. Furthermore, controller 102 may be coupled to one or more of conveyor speed controller 112, screed width controller 114, track speed controller 116, angle of attack controller 122, screed angle controller 126, screed height controller 130, and/or auger speed controller 134. Additionally, machine 2 may include one or more additional actuators or controllers to control the movement of machine 2 and its components, such as, for example, a steering direction sensor, a steering direction controller, an emulsion spray bar controller, etc. Each of the sensors, controllers, and/or actuators may be in communication (e.g., a wired connection or a wireless connection) with each other, for example, through controller 102. Moreover, in one aspect, one or more of conveyor speed controller 112, screed width controller 114, track speed controller 116, angle of attack controller 122, screed angle controller 126, screed height controller 130, and/or auger speed controller 134, and any other controllers of machine 2 may be part of controller 102, or separate from controller 102.

Although not shown, controller 102 may be in communication with additional sensors mounted to or within machine 2, for example, an odometer, a speedometer, temperature sensors, etc. Furthermore, although not shown, controller 102 may be coupled to or otherwise in communication with one or more additional position sensors, for example, one or more LIDAR sensors, one or more stringline sensors, one or more universal total station monitors. Moreover, controller 102 may be in communication with additional displays or operator stations, for example, a central control station for the worksite, an electronic log that records the positions and other operational aspects of machine 2 over a worksite, etc. Furthermore, although not shown, controller 102 may be in communication with one or more other machines. For example, controller 102 may be in communication with a supply truck supplying paving material to hopper 14, for example, to steer the supply truck, control the delivery of paving material to hopper 14 from the supply truck, and/or control the speed of the supply truck in order to correspond to the steering and/or speed of machine 2.

Control panel 36 may be operable to control the delivery of paving material by controlling at least one of a conveyor speed, screed width, and/or track speed, for example, via controller 102. Alternatively or additionally, control panel 36 may be operable to set machine 2 in an automated or semi-automated navigation mode. In one aspect, control panel 36 may include a touch screen user interface 110 and/or other displays or input devices that may be in communication with controller 102. User interface 110 may include a display and a user input, such as, for example, a touch screen, a keyboard, joystick, etc. User interface 110 may be incorporated in control panels 36 or otherwise positioned on machine 2. Alternatively or additionally, one or more user interfaces 110 may be remote to machine 2, for example, a tablet, laptop, or a handheld device carried by an operator and/or positioned in a control center for the worksite. User interface 110 may display the position of machine 2 and/or one or more obstacles on the worksite based on the information received from obstacle detection element(s) 4 and/or position sensor 40.

One or more user interfaces 110 may also include various user inputs. For example, user interface 110 may include an operator selection mechanism. For example, control panel 36 may be configured to allow an operator to set machine 2 in an automated or semi-automated navigation mode. In the automated or semi-automated navigation mode, controller 102 and the various sensors and controllers discussed herein may control the movement of machine 2, including a speed of paving machine 2, a direction of paving machine 2, a delivery of emulsion fluid from spray bar 8, a speed of auger 16, a width of screed assembly 10, a height of screed assembly 10, an angle or angle of attack of screed assembly 10, a speed of conveyor assembly 32, etc. User interface 110 may also include an operator override, which may allow the operator to control the navigation and/or other parameters of machine 2, for example, temporarily interrupting the automated or semi-automated navigation or ending the automated or semi-automated navigation.

Conveyor speed sensor 104 may be coupled to and/or monitor a portion of conveyor assembly 32. In one aspect, conveyor speed sensor 104 may be a rotational speed sensor coupled to or built in with one or more a motor (e.g., a hydraulic motor) that drives one or more conveyor pulleys 44. Alternatively or additionally, conveyor speed sensor 104 may be coupled to and/or monitor conveyor belt 42 or one or more conveyor pulleys 44. Furthermore, in another aspect, conveyor speed sensor 104 may be configured to determine the speed at which paving material is moving on conveyor belt 42.

Furthermore, controller 102 may also be coupled to material sensor 34, for example, to determine a height of material on one or more portions of conveyor assembly 32. With the conveyor speed from conveyor speed sensor 104 and the height of material on one or more portions of conveyor assembly 32, controller 102 may determine a volumetric flow rate of material (e.g., an instantaneous volumetric flow, a volume of material delivered over a period of time, etc.) being delivered from hopper 14 to auger 16 and the remainder of screed assembly 10. Conveyor speed controller 112 may be coupled to one or more conveyor pulleys 44, for example, to control the rotational rate of one or more conveyor pulleys 44. In one aspect, conveyor speed controller 112 may include a motor coupled to and driving the rotation of one or more conveyor pulleys 44 in order to rotate the one or more conveyor pulleys 44 and thus control the movement of conveyor belt 42. Conveyor speed sensor 104 and conveyor speed controller 112 are coupled to controller 102 in order to determine and control a speed of conveyor belt 42. In these aspects, controller 102 may signal conveyor speed controller 112 control the rotational rate of conveyor pulley(s) 44 to control the speed of conveyor assembly 32, and thus control the volumetric flow of material being delivered from hopper 14 to auger 16 and the remainder of screed assembly 10.

Screed width sensor 106 may be coupled to and/or monitor a portion of screed assembly 10 and may help determine a width of screed assembly 10. As discussed above, screed assembly 10 may include left extender screed 406 and right extender screed 407, which may each be extendable and retractable, for example, relative to main screed 18, to control a width of screed assembly 10. Screed width sensor 106 may be coupled to left extender screed 406 and right extender screed 407 in order to determine an extension or retraction of each of the left and right screed portions to determine an overall width of screed assembly 10. Screed width controller 114 may also be coupled to screed assembly 10, for example, to left extender screed 406 and right extender screed 407. Screed width controller 114 may include one or more drive assemblies or actuators 432 (e.g., hydraulic cylinders or other drive elements) configured to adjust the width of screed assembly 10, for example, by controlling the lateral extension or retraction of one or more of left extender screed 406 and screed right extender 407, for example, relative to main screed 18. Screed width sensor 106 and speed width controller 114 are coupled to controller 102 in order to determine and control a width of screed assembly 10.

Track speed sensor 108 may be coupled to and/or monitor one or more portions of drive assembly 24 and may help determine a ground speed of machine 2. In one aspect, track speed sensor 108 may be coupled to and/or monitor one or more of drive wheel 26, idlers 28, and/or tracks 30. Track speed controller 116 may also be coupled to a portion of engine assembly 22 and/or drive assembly 24, for example, to drive wheel 26. Track speed controller 116 may be coupled to and control a motor coupled to and driving the rotation of drive wheel 26 in order to rotate drive wheel 26 and thus control the movement of track 30. Track speed sensor 108 and track speed controller 116 are coupled to controller 102 in order to determine and control a speed of track 30, and thus help determine and control a ground speed of machine 2. Additionally, although not shown, control system 100 may include two track speed sensors 108 and two track speed controllers 116, for example, for left and right tracks 30 that propel machine 2. In this aspect, controller 102 may receive information from one or more track speed sensors 108 and/or signal one or more of track speed controllers 116 in order to steer machine 2. For example, track speed controllers 116 may signal one drive wheel 26 on one side of machine 2 to rotate at a greater speed than the other drive wheel 26 such that one track 30 moves at a greater speed than the other track 30.

As mentioned above, machine 2 may include position sensor 40, for example, mounted on or extending from canopy 21, as shown in FIG. 1. Position sensor 40 may help to determine a position of machine 2 on a worksite and/or relative to other machines and/or topographical features. Position sensor 40 may also help to determine an overall ground speed for machine 2. Position sensor 40 may be coupled to controller 102 in order to determine a position of machine 2 on the worksite and/or relative to other machines and/or topographical features. In these aspects, controller 102 may signal one or more controllers (e.g., screed width controller 114, track speed controller 116, etc.) in order to steer or otherwise control machine 2 to avoid other machines and/or other topographical features.

Angle of attack sensor 120 may be coupled to, positioned on, and/or monitor a portion of screed assembly 10 and may help determine an angle of attack of screed assembly 10. As discussed above, screed assembly 10 (e.g., main screed 18 in FIG. 3) may include front end 18A and rear end 18B, with the angle between front end 18A and 18B being adjustable to control an angle of attack of screed assembly 10. Angle of attack sensor 120 may be an inclinometer positioned on a portion of screed assembly 10, for example, on main screed 18. Angle of attack controller 122 may also be coupled to screed assembly 10, for example, to one or more portions of main screed 18. Angle of attack controller 122 may include one or more drive assemblies or actuators (e.g., hydraulic cylinders) configured to adjust the angle of attack of screed assembly 10, for example, by changing a height of tow points 52 (e.g., by raising or lowering tow point cylinders 54, FIG. 1), changing a tamper bar speed, changing a prestrike off height, adding counter balance, and/or verifying a proper head of paving material ahead of screed assembly 10. As mentioned above, the head of material may be adjusted or verified by at least controlling the paving speed of paving machine 2, adjusting the material feed ratio setting of conveyor assembly 32, and/or using feeder sensors to control the level of material at the outboard end of auger(s) 16. Angle of attack sensor 120 and angle of attack controller 122 are coupled to controller 102 in order to determine and control the angle of attack of screed assembly 10. In one example, if obstacle detection elements 4 detect a pile of material (e.g., asphalt or another paving material), then angle of attack controller 122 may adjust an angle of attack of screed assembly 10. For example, if obstacle detection elements 4 detect a pile of material forward of screed assembly 10 (e.g., forward of one or more of left extender screed 406, right screed extender 407, or main screed 18) that may be large enough to affect the height or floatation of screed assembly 10, then angle of attack controller 122 may adjust an angle of attack of screed assembly 10. In this aspect, angle of attack controller 122 may decrease the angle of attack of screed assembly 10. Alternatively or additionally, if one of more of left extender screed 406 or right screed extender 407 are adjusted (e.g., retracted) to avoid an obstacle, then angle of attack controller 122 may adjust (i.e., increase or decrease) the angle of attack of screed assembly 10 in order to maintain a desired texture, density, or one or more other aspects of mat 310 (FIG. 3) being formed behind machine 2.

Screed angle sensor 124 may be coupled to, positioned on, and/or monitor a portion of screed assembly 10 and may help determine an angle (e.g., a lateral angle, that is, a left to right angle or a right to left angle) of screed assembly 10. As discussed above, screed assembly 10 (e.g., main screed 18 in FIG. 3) may include left screed frame 422 and right screed frame 423. Left screed frame 422 may include left inclinometer 440 that may be mounted on an upper portion of left screed frame 422, and right screed frame 423 may include right inclinometer 442 located on an upper portion of right screed frame 422, as shown in FIG. 4A. Inclinometers 440, 442 may each be a part of and/or otherwise connected to screed angle sensor 12414, and may sense a lateral angle of screed assembly 10. Screed angle controller 126 may also be coupled to screed assembly 10, for example, to one or more portions of main screed 18. Screed angle controller 126 may include one or more drive assemblies or actuators (e.g., hydraulic cylinders) configured to adjust the angle of screed assembly 10, for example, by changing a height of one or more tow points 52 (e.g., by raising or lowering one or more tow point cylinders 54, FIG. 1). For example, a left side tow point 52 may be raised or lowered, and a right side tow point 52 may be raised or lowered in order to angle screed assembly 10, for example, relative to frame 12 of machine 2 and/or relative to the ground surface, in order for screed assembly 10 to form a desired mat of material. Screed angle sensor 124 and screed angle controller 126 are coupled to controller 102 in order to determine and control the angle of screed assembly 10. In one example, if obstacle detection elements 4 detect a pile of material (e.g., asphalt or another paving material), then screed angle controller 126 may adjust an angle of screed assembly 10. For example, if obstacle detection elements 4 detect a pile of material forward of screed assembly 10 (e.g., forward of one or more of left extender screed 406, right screed extender 407, or main screed 18) that may be large enough to affect the height, floatation, or angle of screed assembly 10, then screed angle controller 122 may adjust an angle of screed assembly 10. In this aspect, screed angle controller 126 may adjust the angle of screed assembly 10, for example, by raising and/or lowering one or more of left side tow point 52 and/or right side tow point 52. Alternatively or additionally, if one of more of left extender screed 406 or right screed extender 407 are adjusted (e.g., retracted) to avoid an obstacle, then screed angle controller 126 may adjust (i.e., increase or decrease) the angle of screed assembly 10 in order to maintain a desired texture, density, or one or more other aspects of mat 310 (FIG. 3) being formed behind machine 2.

Screed height sensor 128 may be coupled to, positioned on, and/or monitor a portion of screed assembly 10 and may help determine an height of screed assembly 10, for example, relative to frame 12 of machine 2 and/or relative to the ground surface. As discussed above, screed assembly 10 (e.g., main screed 18 in FIG. 3) may include left screed frame 422 and right screed frame 423. Screed height sensor 128 may be positioned on one or more of left screed frame 422 and/or right screed frame 423. Screed height sensor 128 may be sonic sensor, an optical sensor, or another appropriate sensor to determine the height of screed assembly 10. For example, screed height sensor 128 may determine the height of screed assembly 10 relative to frame 12 by measuring the position of a predetermined point (or points) on screed assembly 10 relative to the position of a predetermined point (or points) on frame 12. Alternatively or additionally, screed height sensor 128 may determine the height of screed assembly 10 relative to the ground surface by emitting one or more signals (e.g., sonic or optical signals), and detecting reflected signals from the ground surface. Screed height controller 130 may also be coupled to screed assembly 10, for example, to one or more portions of main screed 18. Screed height controller 130 may include one or more drive assemblies or actuators (e.g., hydraulic cylinders) configured to adjust the height of screed assembly 10, for example, by changing a height of tow points 52 (e.g., by raising or lowering tow point cylinders 54, FIG. 1). For example, left side and right side tow points 52 may be raised in order to raise the height of screed assembly 10. Alternatively, left side and right side tow points 52 may be lowered in order to lower the height of screed assembly 10 in order for screed assembly 10 to form a desired mat of material. Screed height sensor 128 and screed height controller 130 are coupled to controller 102 in order to determine and control the height of screed assembly 10. In one example, if obstacle detection elements 4 detect a pile of material (e.g., asphalt or another paving material), then screed height controller 130 may adjust a height of screed assembly 10. For example, if obstacle detection elements 4 detect a pile of material forward of screed assembly 10 (e.g., forward of one or more of left extender screed 406, right screed extender 407, or main screed 18) that may be large enough to affect the height, floatation, or angle of screed assembly 10, then screed height controller 130 may adjust (e.g., increase or decrease) a height of screed assembly 10. In this aspect, screed height controller 130 may adjust the height of screed assembly 10, for example, by changing a height of tow points 52 (e.g., by raising or lowering tow point cylinders 54). Alternatively or additionally, if one of more of left extender screed 406 or right screed extender 407 are adjusted (e.g., retracted) to avoid an obstacle, then screed height controller 130 may adjust (i.e., increase or decrease) the height of screed assembly 10 in order to maintain a desired texture, density, or one or more other aspects of mat 310 (FIG. 3) being formed behind machine 2.

Auger speed sensor 132 may be coupled to and/or monitor one or more portions of auger 16 and may help determine a rotational speed of auger 16. In one aspect, auger 16 may include two augers 16 (e.g., a left side auger and a right side auger), and auger speed sensor 132 may be coupled to and/or monitor the rotational speeds of the two augers 16. The two augers may rotate separately, for example, at different rotational speeds and/or in different rotational directions, for example, to help spread paving material delivered by conveyor assembly 32 before the paving material is smoothed by screed assembly 10. Auger speed controller 134 may also be coupled to one or more portions of auger 16, for example, to control and/or drive the rotational speed of auger 16. If auger 16 includes two augers 16, the auger speed controller 134 may be coupled to the two augers 16 in order to control and/or drive the rotation of the two augers 16. In these aspects, auger speed controller 134 may be coupled to and control a motor coupled to and driving the rotation of auger(s) 16 in order to rotate auger(s) 16. Auger speed sensor 132 and auger speed controller 134 are coupled to controller 102 in order to determine and control a speed of auger(s) 16, and thus monitor and control the spreading of paving material by auger(s) 16. In some aspects, although not shown, control system 100 may include two auger speed sensors 132 and two track speed controllers 134, for example, for left and right augers 16. In this aspect, controller 102 may receive information from one or more auger speed sensors 132 and/or signal one or more of auger speed controllers 134 in order to monitor and/or control the spreading of paving material.

In one example, if the left side of screed assembly 10 (e.g., left extender screed 406) and the right side of screed assembly 10 (e.g., right extender screed 407) are extended to the same extent, then one auger 16 on the left side of machine 2 may rotate at a same speed as one auger 16 on a right side of machine 2. In another example, if the left side of screed assembly 10 (e.g., left extender screed 406) is extended to a greater extent than the right side of screed assembly 10 (e.g., right extender screed 407), then one auger 16 on the left side of machine 2 may rotate at a greater speed than one auger 16 on a right side of machine 2. Furthermore, if one or more sides of screed assembly 10 (e.g., left extender screed 406 and/or right extender screed 407) are transitioning outward to widen the width of screed assembly 10, then one or more auger(s) 16 may transition to a greater speed. In another aspect, if one or more sides of screed assembly 10 (e.g., left extender screed 406 and/or right extender screed 407) are transitioning inward to narrow the width of screed assembly 10, then one or more auger(s) 16 may transition to a lesser speed.

Additionally, controller 102 may also control the delivery of emulsion fluid through spray bar 8, for example, by controlling the opening and/or closing of one or more valves (not shown) on spray bar 8. In one or more aspects, the number of and/or configuration of valves that are delivering emulsion fluid may correspond to, for example, a speed of machine 2, a steering angle of machine 2, the width of screed assembly 10, etc. such that an appropriate amount of emulsion fluid is delivered to the ground surface. For example, a greater speed of machine 2 may correspond to a greater amount of emulsion fluid being delivered by spray bar 8 to the ground surface. Furthermore, in one or more aspects, a width of spray bar 8 may be adjustable, for example, controlled by one or more spray bar width controllers (not shown). In these aspects, the width of spray bar 8 may correspond to a width of screed assembly 10, for example, corresponding to the extension of one or more of left extender screed 406 and/or right extender screed 407.

FIG. 6 is a flow diagram portraying an exemplary autonomous or semi-autonomous navigation method 600 that may be performed by control system 100 to automatically control various aspects or portions of machine 2. For example, in the autonomous navigation mode, control system 100 may control the entire navigation and control of machine 2. In another example, in the semi-automated mode, control system 100 may control one or more aspects of the navigation and control of machine 2. For example, in the semi-automated mode, the operator may control the steering and/or speed of machine 2, and control system 100 may control one or more of the screed width, angle of attack, screed angle, conveyor speed, auger speed, delivery of emulsion, etc.

Method 600 includes a step 602, where machine 2 may be set in an automated or semi-automated navigation mode. Alternatively, and at any stage of method 600, machine 2 may be set in an operator navigation mode, overriding the automated navigation mode. Method 600 also includes a step 604 that includes initiating a paving operation in the automated or semi-automated navigation mode. Step 604 may include an operator initiating the paving operation. Alternatively, once machine 2 is set in the automated or semi-automated navigation mode, control system 100 may initiate the paving operation. The paving operation may include a predefined or target path, or may be operator-controlled (i.e., with machine 2 steered by the operator).

Method 600 also includes a step 606, which includes monitoring obstacle detection element(s) 4 for one or more obstacles. For example, as discussed above, obstacle detection element(s) 4 may include one or cameras or other sensors, and obstacle detection element(s) may detect one or more obstacles. The obstacles may include a curb, a road shoulder, a berm, an island, a guardrail, a mailbox, a retaining wall, a manhole cover, a pile of asphalt or other material(s), or other topographical features, impediments, materials, or objects on the worksite. The obstacles may include anything that be undesirable to pave over. Alternatively or additionally, the obstacles may include anything for which is may be desirable to adjust one or more parameters of machine 2 to accommodate or otherwise respond to, while still paving over.

Next, if no obstacles are detected by obstacle detection element(s) 4, then method 600 includes a step 608 in which control system 100 continues the paving operation in the automated or semi-automated navigation mode. Method 600 may then return to step 606 and continue to monitor obstacle detection element(s) 4 for any obstacles.

If obstacle detection element(s) 4 detect one or more obstacles, then method 600 may optionally include a step 610 that includes categorizing the detected one or more obstacles. For example, obstacle detection element(s) 4, controller 102, and/or one or more other portions of control system 100 may include a memory storing one or more reference images or other data, and may compare the detected obstacle(s) to the reference images or other data to categorize the one or more obstacles. For example, step 610 may include categorizing the obstacle as an obstacle to be avoided (e.g., a curb, a road shoulder, a berm, an island, a guardrail, a mailbox, a retaining wall, a manhole cover, etc.). Alternatively, step 610 may include categorizing the obstacle as an obstacle to be paved but otherwise accounted for (e.g., a pile of asphalt or other paving material, a dip or hole in the ground surface, a dip or hole in the shoulder, etc.)

Regardless of whether the detected obstacles are categorized, method 600 includes a step 612 in which control system 100 maneuvers or adjusts one or more portions of machine 2. As discussed above, the maneuvering or adjustment may include maneuvering or adjusting one or more of a speed of paving machine 2, a direction of paving machine 2, a delivery of emulsion fluid from spray bar 8, a speed of auger 16, a width of screed assembly 10, a height of screed assembly 10, an angle or angle of attack of screed assembly 10, a speed of conveyor assembly 32, etc. In these aspects, controller 102 may receive information from one or more of conveyor speed sensor 104, screed width sensor 106, track speed sensor 108, angle of attack sensor 120, screed angle sensor 124, screed height sensor 128, auger speed sensor 132, etc. Additionally, controller 102 may signal one or more of conveyor speed controller 112, screed width controller 114, track speed controller 116, angle of attack controller 122, screed angle controller 126, screed height controller 130, auger speed controller, etc. For example, if the paving path includes a manhole cover on a left edge of the paving path (e.g., based on a screed width detected by screed width sensor 106, control system 100 may signal screed width controller 114 to retract left extender screed 406 such that the manhole cover is not paved over. Alternatively, if a pile of asphalt is on a left side of the paving path, control system 100 may signal auger speed controller 134 to slow down auger 16 (e.g., a left side auger) and/or to extend left extender screed 406. In this aspect, machine 2 may encounter the pile of asphalt and incorporate the asphalt in the mat 310 spread over ground surface (FIG. 3). In these aspects, controller 102 may also signal one or more of conveyor speed controller 112, screed width controller 114, track speed controller 116, angle of attack controller 122, screed angle controller 126, screed height controller 130, etc., for example, to adjust one or more of a speed of paving machine 2, a direction of paving machine 2, a delivery of emulsion fluid from spray bar 8, a speed of auger 16, a width of screed assembly 10, a height of screed assembly 10, an angle or angle of attack of screed assembly 10, a speed of conveyor assembly 32, etc.

In another aspect, if a dip or hole is detected on a left side of the paving path, control system 100 may signal conveyor speed controller 112 and/or auger speed controller 134 to increase the speed of conveyor belt 42 (e.g., by increasing the speed of conveyor pulley 44) and/or increase the speed of auger 16 (e.g., the left side auger). In these aspects, machine 2 may encounter the dip or hole and deliver a greater amount of paving material to help fill the dip or hole and form an even and/or level mat 310 (FIG. 3) behind machine 2. Alternatively or additionally, control system 100 may signal screed width controller 114 to extend or retract left extender screed 406, for example, to help maintain a desired height of mat 310 behind machine 2. Furthermore, in some aspects, control system 100 may signal angle of attack controller 122 to increase an angle of attack of screed assembly 10, for example, to help increase a downward force provided by screed assembly 10 to help fill the dip or hole and form an even and/or level mat 310 behind machine 2. Increasing the angle of attack of screed assembly 10 may also help to increase a density of paving material delivered to the ground surface to help fill the dip or hole and form an even and/or level mat 310 behind machine 2. As discussed with respect to the pile of asphalt or other paving material, controller 102 may also signal one or more of track speed controller 116, screed angle controller 126, screed height controller 130, etc., for example, to adjust one or more of a speed of paving machine 2, a direction of paving machine 2, a delivery of emulsion fluid from spray bar 8, a speed of auger 16, a height of screed assembly 10, etc.

Next, method 600 includes a step 614, in which control system 100 determines whether the one or more obstacles have been avoided or otherwise accounted for. Step 614 may include receiving images or other data from obstacle detection element(s) 4, and determining whether the detected obstacles are no longer in the paving path.

If the one or more obstacles have not yet been avoided or otherwise accounted for, for example, if the manhole cover is still in the paving path, then method 600 includes a step 616, in which control system 100 maneuvers or adjusts one or more portions of machine 2. For example, controller 102 may signal screed width controller 114 to further retract left extender screed 406. Alternatively or additionally, if the manhole cover is still in the paving path, then controller 102 may signal track speed controller 116, for example, to slow down or stop track(s) 30 of machine 2. Alternatively or additionally, controller 102 may signal track speed controller 116 to slow down or stop only one track 30 of machine 2 (or to speed up another track 30 of machine), such that machine 2 turns in order to avoid the manhole cover. Moreover, controller 102 may, additionally or alternatively, signal one or more of conveyor speed controller 112, screed width controller 114, track speed controller 116, angle of attack controller 122, screed angle controller 126, screed height controller 130, auger speed controller, etc., for example, to adjust one or more of a speed of paving machine 2, a direction of paving machine 2, a delivery of emulsion fluid from spray bar 8, a speed of auger 16, a width of screed assembly 10, a height of screed assembly 10, an angle or angle of attack of screed assembly 10, a speed of conveyor assembly 32, etc.

If the one or more obstacles have been avoided or otherwise accounted for, for example, if the manhole cover is no longer in the paving path, then method 600 includes a step 618. Step 618 includes control system 100 maneuvering or adjusts one or more portions of machine 2 and/or continues the paving operation in the automated or semi-automated navigation mode. For example, controller 102 may signal screed width controller 114 to further extend left extender screed 406 to the original position before left extender screed 406 was retracted to avoid the manhole cover. Alternatively or additionally, if the manhole cover is still no longer the paving path, then controller 102 may signal track speed controller 116, for example, to speed up track(s) 30 of machine 2. For example, controller 102 may signal track speed controller 116 to speed up only one track 30 of machine 2 (or to slow down another track 30 of machine), such that machine 2 returns to the original paving path after avoiding the manhole cover. In another example, controller 102 may signal auger speed controller 134 to speed up auger 16 (e.g., a left side auger) and/or to retract left extender screed 406 after the pile of asphalt has been incorporated in the mat 310 spread over ground surface (FIG. 3). Moreover, controller 102 may, alternatively or additionally, signal one or more of conveyor speed controller 112, screed width controller 114, track speed controller 116, angle of attack controller 122, screed angle controller 126, screed height controller 130, auger speed controller, etc., for example, to adjust one or more of a speed of paving machine 2, a direction of paving machine 2, a delivery of emulsion fluid from spray bar 8, a speed of auger 16, a width of screed assembly 10, a height of screed assembly 10, an angle or angle of attack of screed assembly 10, a speed of conveyor assembly 32, etc. to the original parameter, orientation, configuration, etc.

### Industrial Applicability

The disclosed aspects of machine 2 may be used in any paving machine to assist in automated navigation and steering over a worksite. During a paving operation, for example, an operator may set control system 100 to conduct an automated or semi-automated navigation mode for the paving operation on the worksite, in step 602. Step 602 may include activating a pre-programmed paving operation or paving area, for example, a pre-determined width and length of paving material over a paving course. The paving course may be overlaid on a map of the area to be paved. Control system 100 or the operator may then initiate the paving operation, in step 604. Control system 100 may then monitor obstacle detection element(s) 4 for one or more obstacles, in step 606. If no obstacles are detected, then control system 100 may continue the paving operation in the automated or semi-automated navigation mode, in step 608 and continue monitoring for obstacles, for example, in step 606. If one or more obstacles are detected, control system 100 may optionally categorize the detected one or more obstacles, in step 610. For example, control system 100 may categorize the detected obstacles by the size, shape, outline, height (either raised or lowered relative to the ground surface), etc. For example, control system 100 may categorize the obstacles in order to identify the obstacles, as control system 100 may react differently to (i.e., avoid or accommodate) different categories of obstacles.

Control system 100 then maneuvers or adjusts one or more portions of the machine, in step 612. As discussed above, control system 100 may control one or more of a speed of paving machine 2, a direction of paving machine 2, a delivery of emulsion fluid from spray bar 8, a speed of auger 16, a width of screed assembly 10, a height of screed assembly 10, an angle or angle of attack of screed assembly 10, a speed of conveyor assembly 32, etc. Then, in step 614, control system 100 determines whether the one or more obstacles have been avoided. For example, control system 100 may use obstacle detection element(s) 4 to determine whether machine 2 has passed or otherwise avoided the one or more obstacles. If machine 2 has not yet avoided the one or more obstacles, then control system 100 may maneuver or adjust one or more portions of machine 2, in step 616. If machine 2 has avoided the one or more obstacles, then control system 100 maneuvers or adjusts one or more portions of machine 2 and/or continues the paving operation in the automated or semi-automated navigation mode, in step 618. For example, if control system 100 retracted left extender screed 406 to reduce a screed width to avoid a manhole cover on the left side of machine 2, step 618 may include extending left extender screed 406 after avoiding the manhole cover on the left side of machine 2. Furthermore, if control system 100 reduced the speed of auger 16 on the left side of machine 2 in response to the reduced screed width on the left side of machine 2, step 618 may include increasing the speed of auger 16 on the left side of machine 2 after avoiding the manhole cover and extending left extender screed 406.

Control system 100 may navigate and control various portions or parameters of machine 2 while performing a paving operation in the automated or semi-automated navigation mode. As discussed above, control system 100 may accurately navigate machine 2 over the course of a paving operation or otherwise notify an operator of various conditions. Control system 100 may also control various aspects or parameters of screed assembly 10. For example, controller 102 may control the extension or retraction of left extender screed 406 and/or right extender screed 407. Additionally, controller 102 may control the a speed of paving machine 2, a direction of paving machine 2, a delivery of emulsion fluid from spray bar 8, a speed of auger 16, a height of screed assembly 10, an angle or angle of attack of screed assembly 10, a speed of conveyor assembly 32, etc. Furthermore, control system 100 may allow for machine 2 to avoid or otherwise react to obstacles without requiring control or other intervention from the operator(s), potentially improving the efficiency and/or effectiveness of the paving operation. As such, the operator(s) may not require significant training or experience. Furthermore, fewer operators may be required to operate machine 2, reducing operating costs, reducing risks associated with operating machine 2, etc.

It will be apparent to those skilled in the art that various modifications and variations can be made to the disclosed machine and control system without departing from the scope of the disclosure. Other embodiments of the machine and control system will be apparent to those skilled in the art from consideration of the specification and practice of the control system for a paving machine disclosed herein. It is intended that the specification and examples be considered as exemplary only, with a true scope of the disclosure being indicated by the following claims and their equivalents.

What is claimed is:

1. A paving system, comprising:
a paving machine, including a hopper, a conveyor, an auger, a screed assembly, and one or more tracks;
one or more obstacle detection elements positioned on the paving machine; and
a controller in communication with the one or more obstacle detection elements and one or more of the conveyor, the auger, the screed assembly, and the one or more tracks;
wherein the controller is configured to receive information from the one or more obstacle detection elements, and control one or more of a width of the screed assembly, an angle of attack of the screed assembly, a height of the screed assembly, an angle of the screed assembly, or a speed of the paving machine in order to maintain a desired height of paving material delivered to a ground surface by the paving machine.

2. The paving system of claim 1, wherein the one or more obstacle detection elements includes a camera positioned on a forward portion of the paving machine, and wherein the controller is further configured to categorize one or more obstacles detected by the one or more obstacle detection elements.

3. The paving system of claim 1, further comprising a screed width sensor and a screed width controller,
wherein the screed assembly includes a main screed, a left screed extender, and a right screed extender,
wherein the left screed extender and the right screed extender are both extendable and retractable relative to the main screed to adjust the width of the screed assembly, and
wherein the screed width sensor is configured to detect the positions of the positions of the left screed extender and the right screed extender relative to the main screed, and the screed width controller is configured to control the positions of the positions of the left screed extender and the right screed extender relative to the main screed based on the information from the one or more obstacle detection elements.

4. The paving system of claim 3, further comprising an angle of attack sensor, an angle of attack controller, a screed height sensor, and a screed height controller,
wherein the angle of attack sensor is configured to detect an angle of attack of the screed assembly, and the angle of attack controller is configured to control the angle of attack of the screed assembly based on the information from the one or more obstacle detection elements, and
wherein the screed height sensor is configured to detect a height of the screed assembly, and the screed height controller is configured to control the height of the screed assembly based on the information from the one or more obstacle detection elements.

5. The paving system of claim 1, further comprising a conveyor speed sensor and a conveyor speed controller, wherein the conveyor speed sensor is configured to detect a speed of the conveyor, and the conveyor speed controller is configured to control the speed of the conveyor based on the information from the one or more obstacle detection elements.

6. The paving system of claim 5, further comprising an auger speed sensor, an auger speed controller, wherein the auger speed sensor is configured to detect a speed of the auger, and the auger speed controller is configured to control the speed of the auger based on the information from the one or more obstacle detection elements.

7. The paving system of claim 6, further comprising a spray bar, wherein the controller is configured to control delivery of an emulsion fluid through the spray bar based on one or more of the width of the screed, the speed of the auger, the speed of the conveyor, and the speed of the paving machine.

8. The paving system of claim 1, further comprising a track speed sensor and a track speed controller, wherein the track speed sensor is configured to detect a speed of the track, and the track speed controller is configured to control the speed of the track based on the information from the one or more obstacle detection elements.

9. A method of automatically or semi-automatically navigating a paving machine in a paving operation, comprising:
automatically or semi-automatically navigating the paving machine over a worksite;
monitoring one or more obstacle detection elements positioned on the paving machine to detect one or more obstacles in a paving course of the paving machine on the worksite;
if one or more obstacles are detected, maneuvering or adjusting one or more portions of the paving machine;
determining whether the one or more obstacles have been avoided;
maneuvering or adjusting the one or more portions of the paving machine to the original configuration; and
continuing automatically or semi-automatically navigating the paving machine over the worksite.

10. The method of claim 9, further comprising categorizing the detected one or more obstacles as either an obstacle to be avoided or an obstacle to be accommodated during the paving operation.

11. The method of claim 10, wherein if the obstacle is categorized as an obstacle to be avoided, maneuvering or adjusting the one or more portions of the paving machine includes reducing a width of a screed assembly or changing a steering direction of the paving machine.

12. The method of claim 10, wherein if the obstacle is categorized as an obstacle to be accommodated, maneuvering or adjusting the one or more portions of the paving machine includes changing an angle of attack of a screed assembly, a height of the screed assembly, an angle of the screed assembly, or a rotation of one or more augers.

13. The method of claim 10, wherein maneuvering or adjusting one or more portions of the paving machine includes controlling one or more of a width of a screed assembly, an angle of attack of the screed assembly, a height of the screed assembly, or an angle of the screed assembly in order to maintain a desired height of paving material delivered to a ground surface by the paving machine.

14. The method of claim 11, wherein maneuvering or adjusting one or more portions of the paving machine includes controlling one or more tracks of the paving machine to control a speed or direction of the paving machine.

15. The method of claim 12, wherein maneuvering or adjusting one or more portions of the paving machine includes controlling a speed of one or more augers or controlling a delivery of an emulsion fluid through one or more spray bars.

16. A paving machine, comprising:
a conveyor;
a screed assembly, including a main screed, a left screed extender, and a right screed extender;
one or more tracks;
one or more obstacle detection elements positioned on the paving machine; and
a controller in communication with the one or more obstacle detection elements and one or more of the conveyor, the screed assembly, and the one or more tracks;
wherein the controller is configured to receive information from the one or more obstacle detection elements, and control one or more of an extension or retraction of the left screed extender and the right screed extender relative to the main screed, an angle of attack of the screed assembly, a height of the screed assembly, an angle of the screed assembly, or a speed of the one or more tracks to avoid or accommodate one or more obstacles in a path of the paving machine.

17. The paving machine of claim 16, wherein the one or more obstacle detection elements includes a camera positioned on a forward portion of the paving machine.

18. The paving machine of claim 17, further comprising:
a screed width sensor and a screed width controller, wherein the screed width sensor is configured to detect the positions of the positions of the left screed extender and the right screed extender relative to the main screed, and the screed width controller is configured to control the positions of the positions of the left screed extender and the right screed extender relative to the main screed based on the information from the one or more obstacle detection elements;
an angle of attack sensor and an angle of attack controller, wherein the angle of attack sensor is configured to detect an angle of attack of the screed assembly, and the angle of attack controller is configured to control the angle of attack of the screed assembly based on the information from the one or more obstacle detection elements; and
a screed height sensor and a screed height controller, wherein the screed height sensor is configured to detect a height of the screed assembly, and the screed height controller is configured to control the height of the screed assembly based on the information from the one or more obstacle detection elements.

19. The paving machine of claim 16, further comprising a conveyor speed sensor and a conveyor speed controller, wherein the conveyor speed sensor is configured to detect a speed of the conveyor, and the conveyor speed controller is configured to control the speed of the conveyor based on the information from the one or more obstacle detection elements.

20. The paving machine of claim 19, further comprising an auger, an auger speed sensor, an auger speed controller, wherein the auger speed sensor is configured to detect a speed of the auger, and the auger speed controller is configured to control the speed of the auger based on the information from the one or more obstacle detection elements.
